(19) United States
(12) Patent Application Publication
(10) Pub. No.: US 2020/0142056 A1
(43) Pub. Date: May 7, 2020

(54) APPARATUS AND METHODS FOR A SYNTHETIC APERTURE RADAR WITH SELF-CUEING

(71) Applicant: UrtheCast Corp., Vancouver (CA)

(72) Inventors: Peter Allen Fox, Burnaby (CA); Johannes Stephanus Steyn, Vancouver (CA); Michael Richard Davenport, Vancouver (CA)

(21) Appl. No.: 16/616,397

(22) PCT Filed: May 22, 2018
(86) PCT No.: PCT/US2018/033971

§ 371 Date: Nov. 22, 2019

Related U.S. Application Data
(60) Provisional application No. 62/510,132, filed on May 23, 2017.

(51) Int. Cl. G01S 13/90; G01S 7/00

(52) U.S. Cl. CPC G01S 13/9011; G01S 7/006; G01S 13/9021; G01S 13/904

(57) ABSTRACT

A synthetic aperture radar (SAR) system and method of operation advantageously implements dynamic self-cueing or autonomous cueing of successive high-resolution SAR data collection based on previously collected wide-swath SAR data, for instance without the intervention of ground-based resources. For example, target detection may be performed on-board a spaceborne or airborne SAR platform using wide-swath SAR data acquired via a first beam at a first frequency band, the first beam pointed at a first angle relative to an along-track direction. Subsequent activities are cued by the platform based on the previously collected wide-swath SAR data. For instance, the SAR platform may cue subsequent acquisition of SAR data via a second beam at a second frequency band, the second beam pointed at a second angle relative to an along-track direction. The SAR platform may advantageously employ a multi-band SAR antenna.

### TECHNICAL FIELD

The present application relates generally to a synthetic aperture radar (SAR) and, more particularly, to a SAR operating in coordinated wide-swath surveillance and high-resolution imaging modes.

### BACKGROUND

### Description of the Related Art

Multi-Band SAR

Synthetic aperture radar (SAR) is an imaging radar capable of generating finer spatial resolution than conventional beam-scanning radar. A SAR is typically mounted on an airborne or spaceborne platform and designed to acquire images of a terrain such as the Earth or other planets.

A single frequency SAR generates images of the terrain by transmitting radar pulses in a frequency band centered on a single frequency. For example, in the case of the RADARSAT-2 SAR, the center frequency was 5.405 GHz.

Having SAR images acquired at the same time at different frequency bands can be beneficial for remote sensing of the terrain. For example, longer wavelengths (such as L-band) propagate better through vegetation and can provide backscatter from stems or branches, or from the ground below. Shorter wavelengths (such as X-band) tend to provide more backscatter from the canopy. Simultaneous acquisition of SAR images at more than one frequency of illumination (for example, at L-band and X-band) can provide a more complete understanding of the terrain than acquisition of images at a single band.

It can also be desirable for the SAR to be capable of imaging at different polarizations (for example, single polarization and quad polarization), and in different operational modes such as ScanSAR and spotlight SAR.

Some existing SAR systems, such as the Shuttle Imaging Radar SIR-C, can operate at more than one frequency band using separate apertures. Others can operate using a shared aperture. A phased array antenna with steering in both planes can be included in an implementation of a dual-band shared-aperture single-polarization or multi-polarization SAR. A phased array antenna comprises an array of constituent antennas or radiating elements. Each radiating element can be fed by a signal whose phase and amplitude, relative to the phase and amplitude of the signal fed to the other radiating elements, can be adjusted so as to generate a desired radiation pattern for the phased array antenna.

Benefits of a phased array antenna can include flexibility in defining operational modes, reduced power density, redundancy, use of vertical beam steering for ScanSAR, zero Doppler (azimuth) steering and use of vertical beamwidth and shape control for single-beam and/or ScanSAR swath width control.

Target Detection

SAR systems can produce SAR images of the ground day and night, and whether or not there is cloud cover. Images of the ground can include images of scenes on the land or the water surfaces of the Earth. The scenes can include natural features, man-made structures, and vehicles. Images over the ocean, for example, can include images of ships.

SAR systems, and/or other systems for processing SAR images, can include target detection, identification, and, in some cases, automatic target recognition (ATR). ATR can include detection and discrimination methods.

Acquisition Cueing

A SAR system on-board an airborne or spaceborne platform can be commanded from the ground, for example via a communications link between the platform and a ground terminal positioned on the land, sea or in the air. A SAR system can be autonomous, i.e., commanded by an automated subsystem on-board a host airborne or spaceborne platform. A SAR can be commanded by a system or subsystem on-board another airborne or spaceborne platform. An autonomous SAR system or a SAR system commanded by a system or subsystem on-board another airborne or spaceborne platform can also be commanded from the ground. Commanding can include the cueing of image acquisition activities and/or the processing of acquired data.

In one example, a pair of satellites can fly in tandem, one satellite leading, and the other trailing closely behind, to be positioned to image the same targets on the ground. The first satellite may acquire SAR data, determine a location of a target of interest, assess cloud cover, and based on an extent of cloud cover, cue acquisition of additional SAR data or cause the second satellite to capture optical imaging data. See, for example, International Patent Application Publication WO 2017/048339 entitled “SYSTEMS AND METHODS FOR REMOTE SENSING OF THE EARTH FROM SPACE”

### BRIEF SUMMARY

The technology described in this application includes apparatus and methods for acquisition of wide-swath and high-resolution images using a single-band, dual-band or multi-band SAR able to perform on-board data processing, dynamic self-cueing or autonomous cueing, and commanding of the SAR. Acquisition of wide-swath and high-resolution images can overlap in time. In some implementations, acquisition of wide-swath and high-resolution images can be simultaneous or near-simultaneous with each other, for example within seconds of each other, within the same pass, and within the same acquisition window. Acquired wide-swath and high-resolution images can overlap in geographic coverage.

In some implementations, the technology includes the combining of pre-steered beams of different frequencies using an electronically steered phased array with pre-steered subarrays to achieve large steering angles with a small number of phase centers. In other implementations, the beams are dynamically-steered. In yet other implementations, the subarrays are unsteered. The implementation can depend at least in part on the steering angles achievable with the number of phase centers.

As described above, the technology can include simultaneous or near simultaneous acquisition of data by a dual frequency or multi-frequency SAR. The technology can include on-board self-cueing and commanding capability that allows high resolution imaging in one band to be captured simultaneously, near simultaneously, or concurrently) with wide swath surveillance band imaging. The technology can include dynamic self-cueing and commanding by the SAR, and acquisition of high-resolution images in one band simultaneously, near simultaneously, or concurrently) with the acquisition of wide-swath surveillance band imaging in a second band. The dynamic self-cueing and commanding by the SAR to acquire high-resolution imagery can be at least in part in response to information received from the wide-swath surveillance imagery e.g., in response to the detection of targets in the wide-swath imagery. The dynamic self-cueing and commanding by the SAR to acquire high-resolution imagery can be at least in part in response to ancillary information such as a previously-commanded standing order (e.g., to obtain an image of a specified target or region). The dynamic self-cueing and commanding by the SAR to acquire high-resolution imagery can be at least in part in response to a combination of ancillary information an information received from the wide-swath surveillance imagery. Acquisition of the high-resolution imagery can occur without interruption to an on-going acquisition of wide-swath surveillance imagery.

The technology can include machine intelligence to enable self-cueing or autonomous cueing.

The technology may have applications in situational awareness, disaster management, maritime surveillance, and search and rescue, for example.

A method of operation of a synthetic aperture radar (SAR) system comprising at least one SAR antenna, a SAR processor, a SAR controller, and a communication antenna may be summarized as including: acquiring, by a first beam of the at least one SAR antenna, wide-swath SAR data at a first frequency band, the first beam of the at least one SAR antenna pointed at a first angle relative to an along-track direction; processing, by the SAR processor, at least a portion of the wide-swath SAR data; detecting, by the SAR processor, a target in the wide-swath SAR data; cueing, by the SAR controller, acquisition of high-resolution SAR data, the high-resolution SAR data including data backscattered by the target; and in response to cueing, by the SAR controller, acquisition of high-resolution SAR data, acquiring, by a second beam of the at least one SAR antenna, high-resolution SAR data at a second frequency band, the second beam of the at least one SAR antenna pointed at a second angle relative to an along-track direction.

Acquiring, by a second beam of the at least one SAR antenna, high-resolution SAR data at a second frequency band may include acquiring, by a second beam of the at least one SAR antenna, high-resolution SAR data at a second frequency band, the second frequency band different from the first frequency band. Acquiring, by a first beam of the at least one SAR antenna, wide-swath SAR data at a first frequency band may include acquiring, by a first beam of a shared-aperture multi-band SAR antenna, wide-swath SAR data at a first frequency band, and acquiring, by a second beam of the at least one SAR antenna, high-resolution SAR data at a second frequency band may include acquiring, by a second beam of the shared-aperture multi-band SAR antenna, high-resolution SAR data at a second frequency band. Acquiring, by a first beam of a shared-aperture multi-band SAR antenna, wide-swath SAR data at a first frequency band may include acquiring, by a first beam of a planar phased array antenna, wide-swath SAR data at a first frequency band, and acquiring, by a second beam of the shared-aperture multi-band SAR antenna, high-resolution SAR data at a second frequency band may include acquiring, by a second beam of the planar phased array antenna, high-resolution SAR data at a second frequency band.

The method of operation of a synthetic aperture radar (SAR) system comprising at least one SAR antenna, a SAR processor, a SAR controller, and a communication antenna may further include: processing, by the SAR processor, at least a portion of the high-resolution SAR data to form an image of the target; and transmitting, by the communication antenna, to a receiving terminal at least one of the high-resolution SAR data and the image of the target; wherein acquiring, by the second beam, high-resolution SAR data at a second frequency band may occur without interruption to acquiring, by the first beam, wide-swath SAR data at a first frequency band.

Acquiring, by a first beam of the at least one SAR antenna, wide-swath SAR data at a first frequency band may include pointing the first beam at a first angle relative to an along-track direction. Pointing the first beam at a first angle relative to an along-track direction may include pointing the first beam forward of broadside. Pointing the first beam forward of broadside may include dynamically steering the first beam. Acquiring, by a second beam of the at least one SAR antenna, high-resolution SAR data at a second frequency band may include pointing the second beam at a second angle relative to an along-track direction. Pointing the second beam at a second angle relative to an along-track direction may include pointing the second beam aft of the first beam. Pointing the second beam aft of the first beam may include pointing the second beam aft of broadside. Pointing the second beam aft of the first beam may include dynamically steering the second beam. Acquiring, by the second beam of the at least one SAR antenna, high-resolution SAR data at a second frequency band may include acquiring, by the second beam of the at least one SAR antenna, high-resolution SAR data at a second frequency band, the second frequency band including a radar frequency higher than the first frequency band. Processing, by the SAR processor, at least a portion of the wide-swath SAR data may include performing range compression and azimuth compression. Detecting, by the SAR processor, a target in the wide-swath SAR data may include at least one of a single-feature-based method, a multi-feature-based method, or an expert-system-oriented method. Identifying, by the SAR processor, a target in the wide-swath SAR data may include performing a constant false alarm rate (CFAR) detection. Detecting, by the SAR processor, a target in the wide-swath SAR data may include detecting, by the SAR processor, at least one of a natural feature, a man-made structure, or a vehicle, the target situated on a land surface or a water surface of the Earth. Transmitting, by the communication antenna, to a receiving terminal may include transmitting, by the communication antenna, to a ground terminal, the ground terminal situated on one of a land surface of the Earth, a water surface of the Earth, or in the Earth's atmosphere. Acquiring, by a first beam of the at least one SAR antenna, wide-swath SAR data at a first frequency band may include acquiring, by a first beam of the at least one SAR antenna, wide-swath SAR data at a first frequency band with a swath width exceeding 50 km. Acquiring, by a second beam of the at least one SAR antenna, high-resolution SAR data at a second frequency band may include acquiring, by a second beam of the at least one SAR antenna, high-resolution SAR data at a second frequency band with a swath width less than 50 km. Acquiring, by a second beam of the at least one SAR antenna, high-resolution SAR data at a second frequency band may include acquiring, by a second beam of the at least one SAR antenna, high-resolution SAR data at a second frequency band, the second frequency band the same as the first frequency band.

A synthetic aperture radar (SAR) system may be summarizes as including at least one SAR antenna, a SAR processor, a SAR controller, and a communication antenna, the SAR system operable to perform the methods discussed above.

The SAR processor, the SAR controller, and the communication antenna may be co-located on a spaceborne or airborne SAR platform. The spaceborne SAR platform may be a free-flying spacecraft. The at least one SAR antenna may include a plurality of sub-arrays, each sub-array pre-steered to a respective selected steering angle.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram illustrating operation of a dual-band SAR in accordance with the systems and methods described in the present application.

FIG. 2 is a flow chart illustrating a method of operation of a SAR (such as the dual-band SAR of FIG. 1) in accordance with the systems and methods described in the present application.

FIG. 3A is a schematic diagram illustrating operation of a SAR (such as the dual-band SAR of FIG. 1) acquiring wide-swath surveillance SAR data in ScanSAR mode, in accordance with the systems and methods described in the present application.

FIG. 3B is a schematic diagram illustrating operation of a SAR (such as the dual-band SAR of FIG. 1) acquiring high-resolution SAR data in strip-map mode, in accordance with the systems and methods described in the present application.

FIG. 4A is a timing diagram illustrating a relative timing of acquisition and processing of wide-swath surveillance SAR data in ScanSAR mode and high-resolution SAR data in strip-map mode, in accordance with the systems and methods described in the present application.

FIG. 4B is a schematic diagram illustrating a relative timing of processing of high-resolution SAR data in strip-map mode, in accordance with the systems and methods described in the present application.

FIG. 5 is a block diagram of a SAR system, in accordance with the systems and methods of the present application.

FIG. 6 shows an example efficient planar phased array antenna assembly, in accordance with the systems and methods described in the present application.

### DETAILED DESCRIPTION

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one implementation” or “an implementation” or “one embodiment” or “an embodiment” means that a particular feature, structure or characteristic described in connection with the implementation or embodiment is included in at least one implementation or at least one embodiment. Thus, the appearances of the phrases “one implementation” or “an implementation” or “in one embodiment” or “in an embodiment” in various places throughout this specification are not necessarily all referring to the same implementation or the same embodiment. Furthermore, the particular features, structures, or characteristics may be combined in any suitable manner in one or more implementations or one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The Abstract of the Disclosure provided herein is for convenience only and does not interpret the scope or meaning of the embodiments.

As used herein, and in the claims, cueing means the scheduling and commanding of an activity such as the pointing of a remote sensing instrument (such as a SAR) and/or acquisition of data using the remote sensing instrument.

As used herein, and in the claims, self-cueing means the cueing of a remote sensing instrument in response to information derived from data previously acquired by the same remote sensing instrument.

As used herein, and in the claims, autonomous cueing means the cueing of a remote sensing instrument by the remote sensing instrument in the absence of external initiation of the cueing. Autonomous cueing may take place in the context of one or more pre-set rules or guidelines for cueing that may be provided externally.

As used herein, and in the claims, pre-steered beam means a steered beam of an antenna for which the value of the steering angle depends at least in part on fixed or permanent elements introduced during manufacture of the antenna that cause the beam to be steered to a selected angle.

As used herein, and in the claims, dynamically-steered beam means a steered beam of an antenna for which the value of the steering angle depends at least in part on adjustments made or instructions provided by a processor post-manufacture in response to a request to steer the beam to a selected angle.

As used herein, and in the claims, real time means the actual time during which an activity occurs. In the context of the present application, real time refers to an activity such as data processing that occurs without delay once the data is available.

As used herein, and in the claims, target means an object that reflects a radar signal from a transmitter and returns a signal to a receiver.

### Example Implementation

In one implementation, the SAR is a dual-band SAR able to acquire data at L-band and X-band. The SAR is operated to provide broad-area (wide-swath) surveillance using a ScanSAR mode at L-band. The L-band ScanSAR data is processed in real time by a SAR Processor and Controller Unit (SPCU). Processing of the ScanSAR data, including target detection, is performed by the SPCU within a single ScanSAR cycle. In some implementations, target detection includes at least one of vehicle detection and watercraft detection.

The SPCU generates a list of detected targets to be imaged at high-resolution, and provides commands to the SAR sensor electronics. The SAR sensor electronics commands the SAR to acquire high-resolution data at X-band of at least some of the detected targets. The high-resolution X-band SAR data can be acquired in a multi-aperture strip-map mode, for example. Acquisition of high-resolution data at X-band can occur at the same time as ScanSAR surveillance, i.e., without interruption to the acquisition of L-band ScanSAR data.

It is at least theoretically possible that persistent coverage, detection, tracking, discrimination and classification of targets or objects (e.g., surface threats) could be achieved using a constellation of ultra-high resolution wide swath SARs. Systems and methods described in the present application enable persistent coverage, detection, tracking, discrimination and classification of targets or objects by using a SAR in both wide swath surveillance mode (e.g., 200 km swath or more) and ultra-high resolution mode (e.g., 1 m resolution or less) with self-cueing.

A benefit of the apparatus and methods described in this application is that it can provide a lower-cost solution based on a smaller-aperture, simultaneous dual-frequency SAR. As described above, broad-area maritime surveillance and target detection can be performed by an L-Band ScanSAR, while the presence of detected targets can be used to cue an X-band SAR co-located with the L-band SAR and sharing an aperture. High-resolution strip-map images of the detected targets can be acquired and processed in real time.

With better than 1 m resolution along-track, and a resolution consistent with the 350 MHz X-Band bandwidth, the X-Band image provides the data required for the (multi-aperture and high bandwidth) extraction of raw data around the detections to support fine resolution image chip formation and dual-aperture velocity measurement, which may, for example, be combined into a ship report for low bandwidth downlink. The result enables a persistent maritime domain awareness with significantly reduced downlink requirements that also enables an extension to tactical capabilities.

In an example implementation, acquisition and processing of wide-swath SAR data and high-resolution stripmap data can be combined into an operating mode suitable for maritime surveillance. A SAR system operable in the maritime surveillance mode can include multi-aperture, dual-band (X and L) antenna technology, and simultaneous dual-band sensor electronics. Dual-band operation can be at X and L bands, for example.

In one implementation, the L-band antenna is squinted forward along-track, and the X-band antenna is squinted aft along-track. In an example operation, the squint angle of the L-band antenna is approximately 4° forward along-track, and the squint angle of the X-band antenna is approximately 0.7° aft along-track. In this example, the X-band beam trails the L-Band beam by at least approximately 4 seconds, which gives sufficient time to process the L-band data to identify targets of interest for the X-band SAR.

In one implementation, the SAR operates at a single frequency band (e.g., X-band or L-band). Operation of the SAR includes a) steering a first beam squinted forward along-track, b) acquiring SAR data in a wide-swath mode with the first beam, c) steering a second beam squinted backward along-track relative to the first beam, d) acquiring SAR data in a high-resolution mode, and e) switching between the first and the second beams.

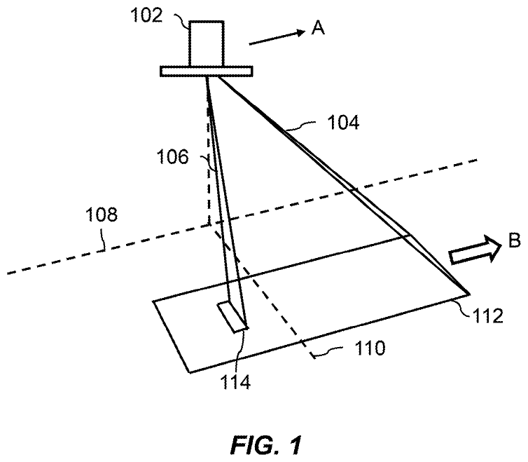

FIG. 1 is a schematic diagram illustrating operation of a SAR 102 in accordance with the systems and methods described in the present application. SAR 102 can be spaceborne SAR, for example a free-flying satellite or an instrument on a space station. SAR 102 can be an airborne SAR. SAR can be a SAR on a drone. SAR 102 can be a SAR on another suitable manned or unmanned spaceborne or airborne platform.

In one implementation, SAR 102 is a SAR operable at a single frequency band. In another implementation, SAR 102 is a dual-band SAR operable at two frequency bands. In yet another implementation, SAR 102 is a multi-band SAR operable at two or more frequency bands. The systems and methods described in the present application are particularly suited to the operation of a dual-band (or multi-band) spaceborne SAR.

In one implementation, SAR 102 includes an L-band SAR and an X-band SAR. In another implementation, SAR 102 includes a C-band SAR, instead of, or in addition to, an L-band SAR and/or an X-band SAR. In yet another implementation, SAR 102 includes another combination of SARs that operate at suitable bands.

In the implementation illustrated in FIG. 1, SAR 102 generates wide-swath beam 104 and high-resolution beam 106. In one implementation, SAR 102 includes an L-band SAR and an X-band SAR, where wide-swath beam 104 is an L-band beam 104, and high-resolution beam 106 is an X-band beam.

With reference to FIG. 1, SAR 102 moves along-track in the direction indicated by the arrow and the letter A. Wide-swath beam 104 is squinted along-track. In a phased array or slotted waveguide antenna, squint refers to the angle that the transmission is offset from the normal of the plane of the antenna. In conventional side-looking SAR, the SAR antenna is pointed perpendicular (i.e., broadside) to the flight path of the SAR (e.g., SAR 102 of FIG. 1). For a squinted beam (such as wide-swath beam 104 of FIG. 1), the angle of squint is the angle at which the antenna is pointed relative to broadside. The angle of squint is typically in the range −10° to +10°. Other squint angles can be used. The dimensions and angles in FIG. 1 are illustrative and not to scale.

Squint can be forward or aft of SAR 102 with respect to a direction of travel of SAR 102 (indicated by arrow A of FIG. 1, for example). In one implementation, wide-swath beam 104 is squinted in the forward direction along-track, such that the ground track of wide-swath beam 104 is ahead of the ground track of SAR 102 in the along-track direction (indicated by arrow B in FIG. 1). The ground track of SAR 102 is defined as a path along the Earth's surface which traces the movement of an imaginary line between SAR 102 and the center of the Earth. A portion of the ground track of SAR 102 is indicated by dashed line 108. Dashed line 110 indicates a broadside direction relative to flight path of SAR 102. While for the purposes of illustration of an example implementation (such as SAR 102 of FIG. 1), it is assumed that the SAR is imaging a surface of the Earth (e.g., land, water, or a combination of land and water), other implementations of the systems and methods described in this application may include imaging the surface of another planetary object such as the Moon or Mars.

It can be desirable for the pointing of the wide-swath and high-resolution beams to be such that there is sufficient time between the wide-swath and high-resolution beams as they pass over a target on the ground to allow for dynamic self-cueing by machine intelligence on-board the SAR platform.

Wide-swath beam 104 illuminates a wide swath 112 on the ground. As is commonly used in the field, the ground includes places and areas on the Earth's surface, for example, land and oceans. As is commonly used in the field, the ground also includes targets on land and/or in the ocean and/or on the ocean surface, or even in the air. In Earth remote sensing applications, wide swath 112 typically has a swath width (across-track dimension) in the range 100 km to 500 km. In one example, the swath width of wide-swath beam 104 is at least 200 km.

In one implementation, wide-swath beam 104 of SAR 102 operates in a ScanSAR mode. ScanSAR mode can provide wide-swath surveillance. In another implementation, wide-swath beam 104 of SAR 102 operates in a strip-map mode or in another suitable imaging mode of SAR 102 to provide wide swath 112. For a more detailed description of SAR operating modes, see for example Moreira A., et al., “A Tutorial on Synthetic Aperture Radar”, IEEE Geoscience and Remote Sensing Magazine (March 2013).

High-resolution beam 106 is squinted along-track. In one implementation, high-resolution beam 106 is squinted in the aft direction along-track, such that the ground track of high-resolution beam 106 is behind the ground track of SAR 102 (relative to broadside) in the along-track direction of movement of SAR 102 indicated by arrow A in FIG. 1. In another implementation, high-resolution beam 106 is pointed forward at a lower squint angle than wide-swath beam 104. In yet another implementation, wide-swath beam 104 and high-resolution beam 106 are both squinted aft, wide-swath beam 104 having a lower squint angle than high-resolution beam 106 (i.e., wide-swath beam pointing more forward than high-resolution beam 106). In yet another implementation, wide-swath beam 104 is squinted forward and high-resolution beam 106 is broadside. In yet another implementation, wide-swath beam 104 is broadside and high-resolution beam 106 is squinted aft.

In one mode of operation of SAR 102, the forward steer of wide-swath beam 104 may be fixed, and the aft steer of high-resolution beam 106 may be adjustable.

High-resolution beam 106 illuminates swath 114 on the ground. High-resolution beam 106 typically illuminates a narrower swath 114 on the ground than wide swath 108 illuminated by wide-swath beam 104. In Earth remote sensing applications, swath 114 typically has a swath width in the range 10 km to 100 km. In one example, swath 114 has a width of 30 km. In one implementation, high-resolution beam 106 operates in a strip-map mode. In another implementation, high-resolution beam 106 operates in another suitable imaging mode of SAR 102.

It is desirable that the relative angle of squint between wide-swath beam 104 and high-resolution beam 106 allows sufficient time for processing of the wide-swath data and subsequent cueing, or self-cueing, and commanding of the acquisition of high-resolution SAR data. The squint of wide-swath beam 104 and high-resolution beam 106 can be built into the sub-arrays of the L-band and the X-band antennas respectively as a fixed squint. With or without fixed squint, the squint angles can be configurable.

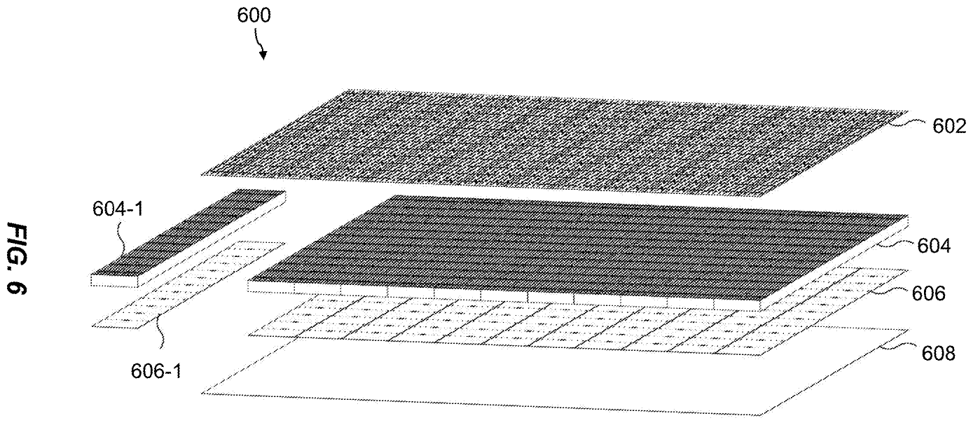

For a typical beam, the grating sidelobes are positioned at an angle from the main lobe of the beam inversely proportional to the distance between the phase centers of sub-array of the antenna (see SAR antenna 600 of FIG. 6, for example). If there are a sufficiently small number of phase centers, the grating sidelobes can be undesirably close to the main lobe of the beam. One approach is to sub-divide each sub-array of the antenna, and apply a fixed phase shift to each of the sub-divisions to generate a fixed squint or steering angle for each sub-array of the antenna. The fixed phase shift can be implemented, for example, in hardware. Building the squint (or steering angle) into the sub-arrays can be referred to as pre-steering the antenna.

A benefit of building the squint into the sub-arrays of the L-band and the X-band antennas is that the number of phase centres required in azimuth can be reduced, with a commensurate reduction in the number of Transmit/Receive Modules (TRMs) in the SAR system. Fewer TRMs can mean significant savings in cost and/or complexity. Another benefit is that it may be possible to achieve greater separation in time of the wide-swath and high-resolution SAR data acquisitions of the same targets, and thereby more time for processing and cueing, or self-cueing, on-board the SAR platform.

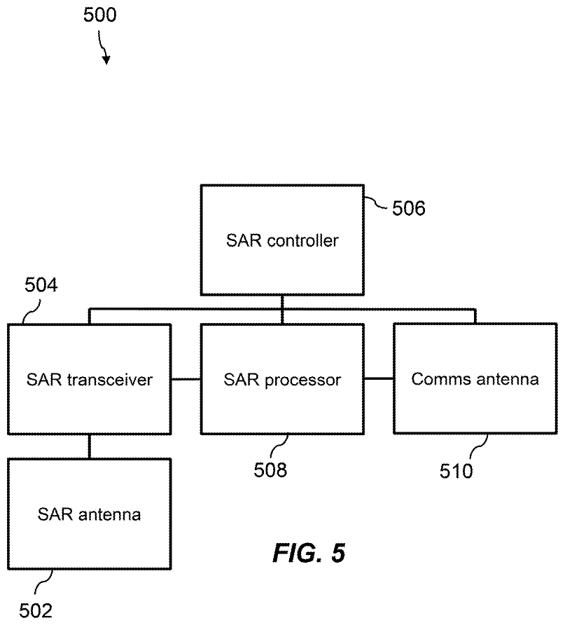

In one implementation, the L-Band SAR data can be processed in real time in a SAR processor (such as SAR processor 502 of FIG. 5) within one ScanSAR cycle. Auto-focusing can be included in the processing though in some scenarios sufficient image quality can be achieved without auto-focusing.

In the time between acquisition of the L-band and X-band SAR data, the SAR processor can generate a list of detected targets to be imaged in ultra-high resolution, and to generate and send the commands via a SAR controller (such as SAR controller 506 of FIG. 5). The commands can implement cueing, or self-cueing, of the SAR system to perform ultra-high resolution X-Band multi-aperture stripmap imaging over the listed target(s).

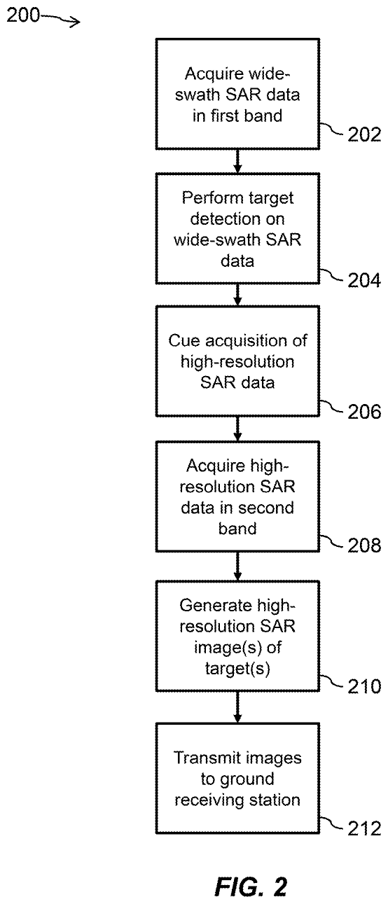

FIG. 2 is a flow chart illustrating a method of operation 200 of a SAR (such as SAR 102 of FIG. 1) in accordance with the systems and methods described in the present application.

At 202, the SAR acquires wide-swath SAR data in a first band. Wide-swath SAR data may be acquired without interruption over an acquisition window. Wide-swath SAR data may be acquired continuously over a time window. Wide-swath SAR data may be acquired in one or more bursts within an acquisition window. Wide-swath SAR data may be acquired during one or more acquisition windows. An acquisition window may be programmed by electronics, or software running on processors, on-board the spacecraft, or the acquisition window may be programmed via commands from a ground station.

In one implementation, the first band is L-band. In another implementation, the first band is one of X-band or C-band. In yet another implementation, the first band is another suitable radar band.

At 204, the wide-swath SAR data is processed, and target detection is performed on the wide-swath SAR data. Processing of the wide-swath SAR data may include processing the wide-swath SAR data to form one or more wide-swath SAR images. Processing of the wide-swath SAR data may include partial processing of the wide-swath SAR data e.g., range compression of the wide-swath SAR data. Processing of the wide-swath SAR data may include processing of one or portions of the wide-swath SAR data. Processing of the wide-swath SAR data may occur on-board the SAR platform (for example, on-board a spacecraft). The systems and methods described in this application are particularly suited to processing of the wide-swath SAR data to form a wide-swath image, the processing occurring on-board the SAR platform.

In one implementation, processing of the wide-swath SAR data includes range compression and azimuth compression. Processing may optionally include other operations such as Doppler Centroid Estimation and autofocusing. In other implementations, other processing schemes can be used e.g., processing to form an image via back-projection. Processing can occur in the time domain and/or the frequency domain.

Target detection may include detection of maritime targets such as ships. Target detection may include detection of targets on or over land such as buildings, trucks, road intersections, and the like. Target detection may be followed by target recognition, identification and/or classification. Target detection may include at least one of a single-feature-based method, a multi-feature-based method, or an expert-system-oriented method. Target detection may be based on a SAR data model. The SAR data model may be a multiplicative SAR data model. Target detection may include constant false alarm rate (CFAR) detection. Target detection may include at least one of signal processing or pattern recognition.

At 206, the SAR cues acquisition of high-resolution SAR data, and, at 208, the SAR acquires high-resolution SAR data in a second band. The second band may be different than the first band. In one implementation, the first band is L-band and the second band is X-band. In one implementation, the resolution of the acquired high-resolution SAR data is approximately 1 m.

Acquisition of high-resolution SAR data can be at least in part in response to the results of target detection performed on the wide-swath SAR data or wide-swath image. For example, acquisition of high-resolution SAR data can be cued for targets detected in the wide-swath SAR data. Acquisition of high-resolution SAR data can be cued at least in part in response to ancillary information. Cueing can be the result of machine intelligence, for example the result of analysis of the wide-swath SAR data and/or the target detection and/or ancillary information. Cueing can include commanding of the SAR to acquire high-resolution SAR data. Cueing can be performed dynamically. Cueing can be performed on-board the SAR platform (for example, on-board a spacecraft).

Acquisition of high-resolution SAR data can occur without interruption to the acquisition of wide-swath SAR data. The systems and methods described in this application are particularly suited to dynamic self-cueing or autonomous cueing of an acquisition of high-resolution SAR data in response to target detection performed on wide-swath SAR data acquired during the same acquisition window, the acquisition of cued high-resolution SAR data a) occurring without interruption to an ongoing acquisition of wide-swath SAR data, and b) intended to capture high-resolution SAR images of targets detected in the wide-swath SAR data.

The high-resolution SAR data can be stored on-board the SAR platform and/or transmitted to another platform e.g., a ground terminal or another spacecraft or aircraft. At 210, the SAR processes the high-resolution SAR data to generate one or more high-resolution SAR images or image chips. An image chip is an image that typically covers a smaller area on the ground than an image generated by processing the available high-resolution SAR data. An image chip may be selected to include one or more previously-detected targets of interest. Processing of the high-resolution SAR data may include generating one or more high-resolution SAR images of the targets identified at 204. Processing of the high-resolution SAR data may include partial processing of the high-resolution SAR data e.g., range compression of the high-resolution SAR data. Processing of the high-resolution SAR data may include processing of one or portions of the high-resolution SAR data. Processing of the high-resolution SAR data may occur on-board the SAR platform. The systems and methods described in this application are particularly suited to processing of the high-resolution SAR data to form one or more images or image chips, the processing occurring on-board the SAR platform.

At 212, the SAR transmits the high-resolution SAR images or image chips to a ground receiving station. A ground receiving station (referred to herein also as a ground terminal) can be on land, sea or air, or in space. The SAR may transmit wide-swath SAR data, wide-swath SAR images, results of target detection, high-resolution SAR data, high-resolution SAR images and/or high-resolution image chips to the ground receiving station.

In some implementations, act 212 may occur before act 210, and the acquired high-resolution SAR data is transmitted to the ground receiving station for processing on the ground.

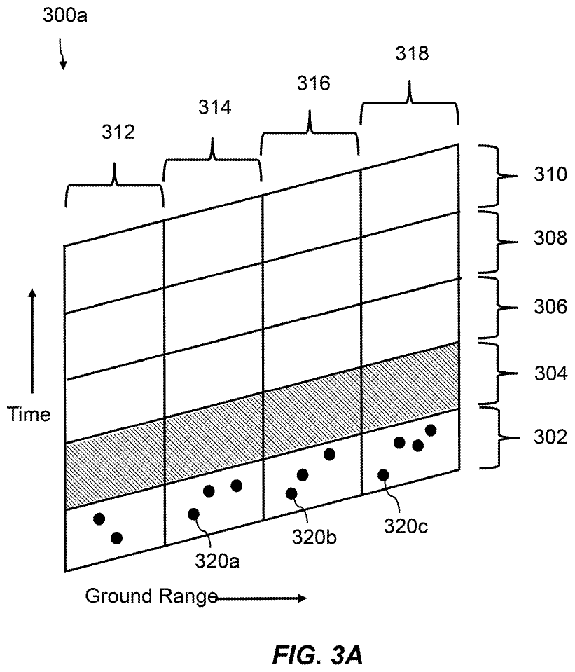

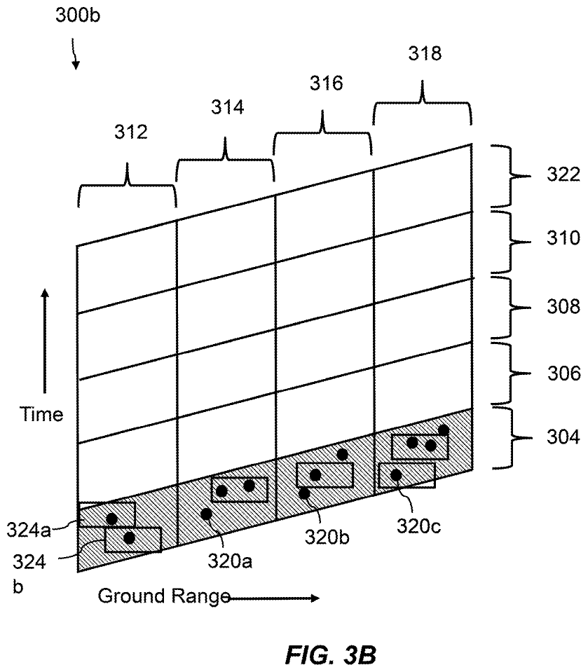

FIG. 3A is a schematic diagram illustrating operation of a SAR (such as SAR 102 of FIG. 1) acquiring wide-swath surveillance SAR data in ScanSAR mode, in accordance with the systems and methods described in the present application.

The SAR acquires wide-swath surveillance SAR data (also referred to in the present application as wide-swath SAR data) in Scan SAR mode in a plurality of ScanSAR cycles such as consecutive ScanSAR cycles 302, 304, 306, 308, and 310.

ScanSAR data is acquired using one or more beams such as beams 312, 314, 316, and 318. In the operation illustrated in FIG. 3A, the SAR is acquiring wide-swath surveillance SAR data in ScanSAR cycle 304, as indicated by the hatching in beams 312, 314, 316, and 318 of ScanSAR cycle 304.

Targets 320a, 320b, and 320c (collectively referred to as 320, only three called out in FIG. 3A) are targets identified by processing ScanSAR data acquired during an earlier ScanSAR cycle e.g., ScanSAR cycle 302.

FIG. 3B is a schematic diagram illustrating operation of a SAR (such as SAR 102 of FIG. 1) acquiring high-resolution SAR data in strip-map mode, in accordance with the systems and methods described in the present application.

The SAR acquires high-resolution SAR data in a plurality of ScanSAR cycles such as consecutive ScanSAR cycles 304, 306, 308, 310, and 322. High-resolution SAR data in strip-map mode is acquired using one or more beams such as beams 312, 314, 316, and 318. Since the pulse repetition frequency (PRF) of the SAR can vary from one beam to another, it is desirable that high-resolution SAR data is acquired for the same beams 312, 314, 316, and 318 as the wide-swath surveillance SAR data.

High-resolution SAR data may be acquired using one or more sub-beams such as sub-beams 324a and 324b. In the operation illustrated in FIG. 3B, the SAR is acquiring high-resolution SAR data in strip-map mode in ScanSAR cycle 304 for targets 320 identified by processing of wide-swath surveillance SAR data acquired in ScanSAR mode during an earlier ScanSAR cycle e.g., ScanSAR cycle 302.

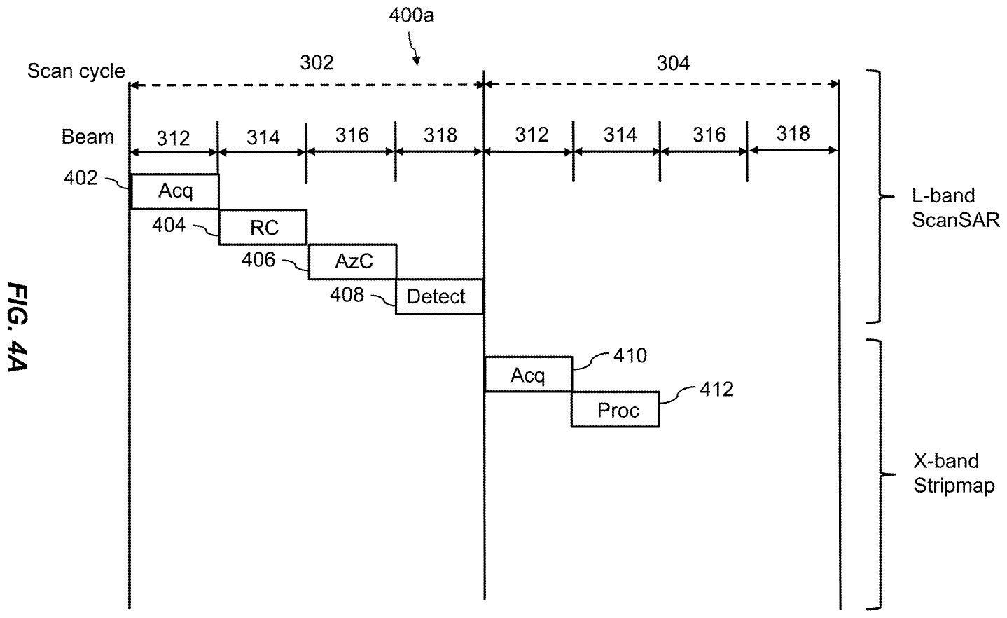

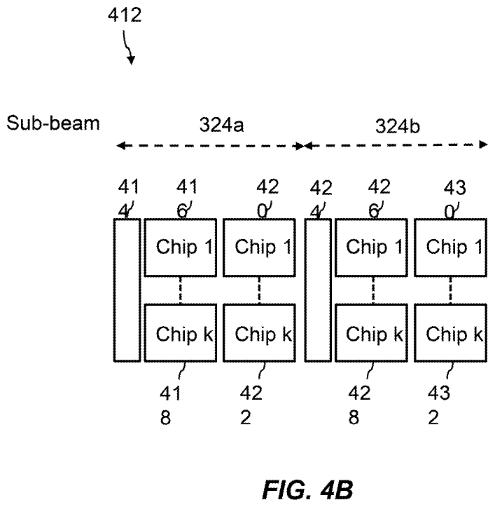

FIG. 4A is a timing diagram 400a illustrating a relative timing of acquisition and processing by a SAR system of wide-swath surveillance SAR data in ScanSAR mode and high-resolution SAR data in strip-map mode, in accordance with the systems and methods described in the present application.

Blocks 402, 404, 406, and 408 illustrate pipeline acquisition and processing of ScanSAR data.

At 402, the SAR system acquires wide-swath surveillance ScanSAR mode data in beam 312 of FIG. 3 in ScanSAR cycle 302 of FIG. 3.

At 404, the SAR system performs range compression of the ScanSAR data acquired at 402. Range compression in the illustrated example is performed during the time allocated to beam 314 of FIG. 3 of ScanSAR cycle 302. Range compression can be performed at another suitable time. The SAR system can acquire wide-swath ScanSAR mode data using beam 314 while the SAR system performs range compression of ScanSAR data acquired using beam 312.

At 406, the SAR system performs azimuth compression of the ScanSAR data acquired at 402. Azimuth compression in the illustrated example is performed during the time allocated to beam 316 of FIG. 3 of ScanSAR cycle 302. Azimuth compression can be performed at another suitable time. The SAR system can acquire wide-swath ScanSAR mode data using beam 316 while the SAR system performs azimuth compression of ScanSAR data acquired using beam 312. In the time allocated to beam 316, the SAR system may also perform range compression of ScanSAR data acquired using 314.

At 408, the SAR system performs target detection using the ScanSAR data acquired at 402. Target detection in the illustrated example is performed during the time allocated to beam 318 of FIG. 3 of ScanSAR cycle 302. Target detection can be performed at another suitable time. The SAR system can acquire wide-swath ScanSAR mode data using beam 318 while the SAR system performs target detection of ScanSAR data acquired using beam 312. In the time allocated to beam 318, the SAR system may also perform range compression of ScanSAR data acquired using 316, and/or azimuth compression of ScanSAR data acquired using beam using beam 314.

Blocks 410 and 412 illustrate pipeline acquisition and processing of high-resolution SAR data.

At 410, the SAR system acquires high-resolution SAR data in beam 312 of ScanSAR cycle 304. Acquiring high-resolution SAR data in beam 312 can be self-cued by the SAR system, and can be in response to the results of target detection at 408. Acquisition of high-resolution SAR data in beam 312 of ScanSAR cycle 304 can be performed at the same time as acquisition of wide-swath SAR data (not shown in FIG. 4A) i.e., acquisition of high-resolution SAR data in beam 312 of ScanSAR cycle 304 can be performed without interrupting the acquisition of wide-swath SAR data in beam 312 of ScanSAR cycle 304.

At 412, the SAR system performs processing of the high-resolution SAR data acquired at 410. Processing of the high-resolution SAR data in the illustrated example is performed during beam 314 of FIG. 3 of ScanSAR cycle 304. Processing of the high-resolution SAR data can be performed at another suitable time. An example implementation of the processing of the high-resolution SAR data at 412 is illustrated in more detail in FIG. 4B.

In one implementation, processing of the high-resolution SAR data includes range compression and azimuth compression. Processing may optionally include other operations such as Doppler Centroid Estimation, autofocusing, velocity estimation, and classification. In other implementations, other processing schemes can be used e.g., processing to form an image via back-projection. Processing can occur in the time domain and/or the frequency domain.

FIG. 4B is a schematic diagram illustrating a relative timing of processing of high-resolution SAR data in strip-map mode, in accordance with the systems and methods described in the present application.

A beam may be divided into two or more sub-beams. In the illustrated example of FIG. 4B, beam 314 of FIG. 4A is divided into two sub-beams 324a and 324b. At 414, the SAR system performs chip extraction for sub-beam 324a to generate one or more image chips from the acquired high-resolution SAR data. At 416, the SAR system performs range and azimuth compression on the first image chip. At 418, the SAR system performs range and azimuth compression on the k^{th} image chip. At 420, the SAR system performs additional processing such as velocity estimation and classification on the first image chip. At 422, the SAR system performs additional processing such as velocity estimation and classification on the k^{th} image chip.

At 424, the SAR system performs chip extraction for sub-beam 324b to generate one or more image chips from the acquired high-resolution SAR data. At 426, the SAR system performs range and azimuth compression on the first image chip. At 428, the SAR system performs range and azimuth compression on the k^{th} image chip. At 430, the SAR system performs additional processing such as velocity estimation and classification on the first image chip. At 432, the SAR system performs additional processing such as velocity estimation and classification on the k^{th} image chip.

Typically, a ScanSAR cycle consists of a number of beams (or bursts), e.g., beams 312, 314, 316, and 318 of ScanSAR cycle 302 of FIG. 3. As illustrated in FIG. 4A, data acquisition can take place during a time allocated to an initial beam, followed by range compression during a time allocated to a subsequent beam (e.g., the next beam), azimuth compression during a time allocated to a further subsequent beam (e.g., the next beam after that), and target detection during a time allocated to yet a further subsequent beam (e.g., the next beam after that). During the time allocated to each beam, acquisition, range compression, azimuth compression, and target detection can occur in parallel. In an example implementation, while data is being acquired, the SAR system can perform range compression of data acquired by the previous beam. The SAR system can in parallel perform azimuth compression of data range-compressed during the time allocated to the previous beam, and can also, in parallel, perform target detection on data azimuth-compressed during the time allocated to the previous beam.

Consequently, in the illustrated example implementation, the latency from the start of range lines to targets detections can be three beam (or burst) periods. The wide-swath SAR image formation and target detection can be completed within a ScanSAR cycle consisting of four beams (as shown in FIG. 4A for example).

In parallel, X-band stripmap acquisition and processing can be performed on data acquired during the previous ScanSAR cycle. The SAR system has sufficient time to synchronize operation of the wide-swath and high-resolution modes.

In the case of a dual-band SAR system where a first band (e.g., L-band) is used to acquire wide-swath SAR data and a second band (e.g., X-band) is used to acquire high-resolution SAR data, the simultaneous dual-band capability of the SAR allows wide-swath surveillance to continue, uninterrupted, while a multi-aperture strip-map image is captured simultaneously (in parallel) with wide-swath surveillance. In one implementation, the high-resolution SAR data for targets detected by the wide-swath beam is acquired using the same beam, and at the same pulse repetition frequency (PRF), in a subsequent ScanSAR cycle e.g., beam 312 of ScanSAR cycles 302 and 304 of FIG. 3.

FIG. 5 is a block diagram of a SAR system 500, in accordance with the systems and methods of the present application. SAR system 500 can be a multi-band SAR system, for example a dual-band XL SAR system. SAR system 500 can be on-board a SAR platform such as an aircraft, unmanned aircraft, drone, satellite, space station, or spacecraft. SAR system 500 comprises a SAR antenna 502, a SAR transceiver 504, a SAR controller 506, a SAR processor 508, and a communications antenna 510.

SAR antenna 502 can be a shared aperture antenna. SAR antenna 502 can be a planar phased array such as described in International Patent Application Publication WO 2017/044168 entitled “EFFICIENT PLANAR PHASED ARRAY ANTENNA ASSEMBLY”, for example. SAR antenna 502 is communicatively coupled to transceiver 504. SAR transceiver 504 can transmit and receive pulses at one or more frequency bands, for example at X-band and L-band. SAR transceiver 504 can transmit and receive pulses for two or more frequency bands at the same time. For example, SAR transceiver 504 can transmit and receive L-band pulses for wide-swath SAR imaging and X-band pulses for high-resolution imaging at the same time (i.e., in the same acquisition window). The pulses can be synchronized with each other. The SAR antenna can transmit and receive pulses for one or more imaging modes such as ScanSAR mode and strip-map mode. SAR transceiver 504 can transmit and receive pulses in one or more beams, and in one or more sub-beams. In some implementations, SAR transceiver 504 includes one or more transmit/receive modules (also referred to in the present application as TR modules). In some implementations, SAR transceiver 504 includes a transmitter and a separate receiver.

SAR controller 506 can comprise one or more processors. SAR controller 506 can include at least one of a Field-Programmable Gate Array (FPGA), an Application Specific Integrated Circuit (ASIC), a microcontroller, and a microprocessor, and one or more programs or firmware stored on one or more nontransitory computer- or processor-readable media.

SAR processor 508 can process SAR data acquired by SAR antenna 502 and SAR transceiver 504. SAR processor 508 can process data in near-real-time. SAR processor 508 can perform range compression, azimuth compression, target detection and identification, chip extraction, velocity estimation, and/or image classification. SAR processor 508 can process data for one or more imaging modes of SAR system 500. In one implementation, SAR processor 508 can process wide-swath ScanSAR mode and high-resolution strip-map mode data. In one implementation, SAR processor 508 can process strip-map mode data and Spotlight mode data. In one implementation, SAR processor 508 can process at least two of wide-swath ScanSAR mode, strip-map mode, high-resolution strip-map mode, and Spotlight mode data.

Communications antenna 510 can transmit and receive data, for example communications antenna 510 can transmit acquired SAR data, processed SAR targets, target detections, identifications, and image classifications from SAR system 500 to a ground terminal. Communications antenna 510 can receive commands and/or ancillary data from a ground terminal. The ground terminal (not shown in FIG. 5) can include a communications antenna and a transceiver.

SAR antenna 502 of FIG. 5 can be a planar phased array antenna. FIG. 6 shows an example efficient planar phased array antenna assembly 600. The size of antenna assembly 600 can be tailored to meet the gain and bandwidth requirements of a particular application. An example application is a dual-band, dual-polarization SAR antenna. In an example implementation of a dual-band, dual-polarization SAR antenna, assembly 600 is approximately 2.15 m wide, 1.55 m long and 50 mm deep, and weighs approximately 30 kg. In another implementation, SAR antenna 502 comprises a single panel of dimensions 6 m by 2 m. In yet another implementation, SAR antenna 502 comprises six panels, each panel of dimensions 1 m by 2 m.

Example antenna assembly 600 of FIG. 6 is a dual-band (X-band and L-band), dual-polarization (H and V polarizations at L-band) SAR antenna assembly. While embodiments described in this document relate to dual X-band and L-band SAR antennas, and the technology is particularly suitable for space-based SAR antennas for reasons described elsewhere in this document, a similar approach can also be adopted for other frequencies, polarizations, configurations, and applications including, but not limited to, single-band and multi-band SAR antennas at different frequencies, and microwave and mm-wave communication antennas.

Antenna assembly 600 comprises a first face sheet 602 on a top surface of antenna assembly 600, containing slots for the L-band and X-band radiating elements. Antenna assembly 600 comprises microwave structure 604 below first face sheet 602. Microwave structure 604 comprises one or more subarrays such as subarray 604-1, each subarray comprising L-band and X-band radiating elements.

Microwave structure 604 can be a metal structure that is self-supporting without a separate structural subassembly. Microwave structure 604 can be machined or fabricated from one or more metal blocks, such as aluminium blocks or blocks of another suitable conductive material. The choice of material for microwave structure 604 determines, at least in part, the losses and therefore the efficiency of the antenna.

Antenna assembly 602 comprises second face sheet 606 below microwave structure 604, second face sheet 606 closing one or more L-band cavities at the back. Second face sheet 606 comprises one or more sub-array face sheets such as 606-1.

Antenna assembly 600 comprises third face sheet 608 below second face sheet 606, third face sheet 608 comprising waveguide terminations. Third face sheet 608 also provides at least partial structural support for antenna assembly 600.

In some implementations, antenna assembly 600 comprises a multi-layer printed circuit board (PCB) (not shown in FIG. 6) below third face sheet 608, the PCB housing a corporate feed network for the X-band and L-band radiating elements.

Example Use Case—Maritime Surveillance

An example use case of the systems and methods described in the present application is simultaneous wide-swath and ultra-high-resolution maritime surveillance. A benefit of the example use case described here is that conventional SAR images of maritime targets such as ships can be replaced or supplemented by high-resolution images of targets likely to provide improved classification. Simultaneous operation of a wide-swath SAR and a high-resolution SAR (or simultaneous acquisition by a SAR of wide-swath SAR data and high-resolution SAR data), and self-cueing or autonomous cueing by the platform of the acquisition and processing of high-resolution images on-board the SAR platform can enable near-real-time identification and high-resolution imaging of targets over a wide swath.

In an example implementation, a dual-band SAR can operate in an L-band ScanSAR mode to provide wide-swath surveillance. Data acquired by the SAR in the L-band ScanSAR mode can be processed in real time on-board the SAR platform using a SAR processor and a SAR controller. Processing can be completed within one ScanSAR cycle to provide the data required for ship detection, for example. The SAR can generate a list of detected targets to be imaged at ultra-high resolution. The SAR can send commands to SAR sensor electronics, and command the dual-band SAR to operate in an X-band strip-map mode to acquire high-resolution or ultra-high-resolution images of the target(s) without interrupting the wide-swath ScanSAR surveillance.

The various embodiments described above can be combined to provide further embodiments. Aspects of the embodiments can be modified, if necessary, to employ systems, circuits and concepts of the various patents, applications and publications to provide yet further embodiments. The teachings of U.S. provisional patent application Ser. No. 62/510,132 are incorporated herein by reference in its entirety.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

While particular elements, embodiments and applications of the present technology have been shown and described, it will be understood, that the technology is not limited thereto since modifications can be made by those skilled in the art without departing from the scope of the present disclosure, particularly in light of the foregoing teachings.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation of a synthetic aperture radar (SAR) system comprising at least one SAR antenna, a SAR processor, a SAR controller, and a communication antenna, the method comprising:
acquiring, by a first beam of the at least one SAR antenna, wide-swath SAR data at a first frequency band, the first beam of the at least one SAR antenna pointed at a first angle relative to an along-track direction;
processing, by the SAR processor, at least a portion of the wide-swath SAR data;
detecting, by the SAR processor, a target in the wide-swath SAR data;
cueing, by the SAR controller, acquisition of high-resolution SAR data, the high-resolution SAR data including data backscattered by the target; and
in response to cueing, by the SAR controller, acquisition of high-resolution SAR data, acquiring, by a second beam of the at least one SAR antenna, high-resolution SAR data at a second frequency band, the second beam of the at least one SAR antenna pointed at a second angle relative to an along-track direction.

2. The method of claim 1 wherein acquiring, by a second beam of the at least one SAR antenna, high-resolution SAR data at a second frequency band includes acquiring, by a second beam of the at least one SAR antenna, high-resolution SAR data at a second frequency band, the second frequency band different from the first frequency band.

3. The method of claim 2 wherein acquiring, by a first beam of the at least one SAR antenna, wide-swath SAR data at a first frequency band includes acquiring, by a first beam of a shared-aperture multi-band SAR antenna, wide-swath SAR data at a first frequency band, and acquiring, by a second beam of the at least one SAR antenna, high-resolution SAR data at a second frequency band includes acquiring, by a second beam of the shared-aperture multi-band SAR antenna, high-resolution SAR data at a second frequency band.

4. The method of claim 3 wherein acquiring, by a first beam of a shared-aperture multi-band SAR antenna, wide-swath SAR data at a first frequency band includes acquiring, by a first beam of a planar phased array antenna, wide-swath SAR data at a first frequency band, and acquiring, by a second beam of the shared-aperture multi-band SAR antenna, high-resolution SAR data at a second frequency band includes acquiring, by a second beam of the planar phased array antenna, high-resolution SAR data at a second frequency band.

5. The method of claim 1 further comprising:
processing, by the SAR processor, at least a portion of the high-resolution SAR data to form an image of the target; and
transmitting, by the communication antenna, to a receiving terminal at least one of the high-resolution SAR data and the image of the target; wherein acquiring, by the second beam, high-resolution SAR data at a second frequency band occurs without interruption to acquiring, by the first beam, wide-swath SAR data at a first frequency band.

6. The method of claim 1 wherein acquiring, by a first beam of the at least one SAR antenna, wide-swath SAR data at a first frequency band includes pointing the first beam at a first angle relative to an along-track direction.

7. The method claim 6 wherein pointing the first beam at a first angle relative to an along-track direction includes pointing the first beam forward of broadside.

8. The method of claim 7 wherein pointing the first beam forward of broadside includes dynamically steering the first beam.

9. The method of claim 1 wherein acquiring, by a second beam of the at least one SAR antenna, high-resolution SAR data at a second frequency band includes pointing the second beam at a second angle relative to an along-track direction.

10. The method of claim 9 wherein pointing the second beam at a second angle relative to an along-track direction includes pointing the second beam aft of the first beam.

11. The method of claim 10 wherein pointing the second beam aft of the first beam includes pointing the second beam aft of broadside.

12. The method of claim 10 wherein pointing the second beam aft of the first beam includes dynamically steering the second beam.

13. The method of claim 1 wherein acquiring, by the second beam of the at least one SAR antenna, high-resolution SAR data at a second frequency band includes acquiring, by the second beam of the at least one SAR antenna, high-resolution SAR data at a second frequency band, the second frequency band including a radar frequency higher than the first frequency band.

14. The method of claim 1 wherein processing, by the SAR processor, at least a portion of the wide-swath SAR data includes performing range compression and azimuth compression.

15. The method of claim 1 wherein detecting, by the SAR processor, a target in the wide-swath SAR data includes at least one of a single-feature-based method, a multi-feature-based method, or an expert-system-oriented method.

16. The method of claim 1 wherein identifying, by the SAR processor, a target in the wide-swath SAR data includes performing a constant false alarm rate (CFAR) detection.

17. The method of claim 1 wherein detecting, by the SAR processor, a target in the wide-swath SAR data includes detecting, by the SAR processor, at least one of a natural feature, a man-made structure, or a vehicle, the target situated on a land surface or a water surface of the Earth.

18. The method of claim 1 wherein transmitting, by the communication antenna, to a receiving terminal includes transmitting, by the communication antenna, to a ground terminal, the ground terminal situated on one of a land surface of the Earth, a water surface of the Earth, or in the Earth's atmosphere.

19. The method of claim 1 wherein acquiring, by a first beam of the at least one SAR antenna, wide-swath SAR data at a first frequency band includes acquiring, by a first beam of the at least one SAR antenna, wide-swath SAR data at a first frequency band with a swath width exceeding 50 km.

20. The method of claim 1 wherein acquiring, by a second beam of the at least one SAR antenna, high-resolution SAR data at a second frequency band includes acquiring, by a second beam of the at least one SAR antenna, high-resolution SAR data at a second frequency band with a swath width less than 50 km.

21. The method of claim 1 wherein acquiring, by a second beam of the at least one SAR antenna, high-resolution SAR data at a second frequency band includes acquiring, by a second beam of the at least one SAR antenna, high-resolution SAR data at a second frequency band, the second frequency band the same as the first frequency band.

22. A synthetic aperture radar (SAR) system comprising at least one SAR antenna, a SAR processor, a SAR controller, and a communication antenna, the SAR system operable to perform operations comprising:
acquiring, by first beam of the at least one SAR antenna, wide-swath SAR data at a first frequency band, the first beam at east one antenna pointed at a first angle relative to an along-track direction;
processing, by the SAR processor, at least a portion of the wide-swath SAR data;
detecting, by the SAR processor, a target in the wide-swath SAR data;
cueing, by tai e SAR controller, acquisition of high-resolution SAR data, the high-resolution SAR data including data backscattered by the target; and
in response to cueing, by the SAR controller, acquisition of high-resolution SAR data, acquiring, by a second beam of the at least one SAR antenna, high-resolution SAR data at a second frequency band, the second beam of the at least one SAR antenna pointed at a second angle relative to an along-track direction.

23. The SAR system of claim 22 wherein the SAR processor, the SAR controller, and the communication antenna are co-located on a spaceborne or airborne SAR platform.

24. The SAR system of claim 23 wherein the spaceborne SAR platform is a free-flying spacecraft.

25. The SAR system of claim 22 wherein the at least one SAR antenna comprises a plurality of sub-arrays, each sub-array pre-steered to a respective selected steering angle.
